(19) United States
(12) Patent Application Publication
(10) Pub. No.: US 2003/0234304 A1
(43) Pub. Date: Dec. 25, 2003

(54) Superfine powders and methods for manufacture of said powders

(76) Inventor: Weifang Miao, Pittsburgh, PA (US)

Correspondence Address: CARL A. RONALD, ESQ., 1500 ONE PPG PLACE, PITTSBURG, PA, 15222, US

(21) Appl. No.: 10/175,976

(22) Filed: Jun. 20, 2002

(51) Int. Cl. B02C 19/12

(52) U.S. Cl. 241/22

(57) ABSTRACT

A method is disclosed for the production of a superfine mineral material powder wherein the subject mineral material is combined with a dry separation agent such as sodium chloride and ground for a sufficient time to produce the superfine mineral material of predetermined size or specific surface area. The separation agent is then removed from the final product by washing it with a solvent such as water. Superfine powders composed of mineral materials where the material is selected from the group consisting of talc, calcium carbonate, zeolite, clay, aluminum hydroxide, aluminum silicate, iron oxide and magnesium oxide are also claimed.

### CROSS REFERENCE TO RELATED APPLICATIONS

Not Applicable.

### BACKGROUND

1. Field of the Invention

This invention relates to a method for the manufacture of superfine particles or powders. Superfine powders, as that term is used herein, is defined as those powders having individual granules possessing an average diameter of the longest dimension smaller than one micron. For the purposes of this Specification, the term “powder” will be used to denote a large number of superfine particles of the particular mineral material being discussed. There are many different minerals that can be made into useful products or ingredients when reduced to the nanometer size range. Also known as mineral fillers, these particles or powders are inexpensive substances that can be added to paints, paper and synthetic materials in order to increase volume, weight, brightness or any of a host of other qualities. The particular quality thus enhanced increases the technical utility and thus the value of the particle or powder and, correspondingly, the value of the ultimate product is increased as well.

It is known, for example, that superfine calcium carbonate can be used as an ingredient for pigment in paper-coating compositions. Particles with an average size smaller than 100 nanometers or so are ideal for high-quality art paper and other coated papers because of the high degree of whiteness inherent in calcium carbonate, good amenability to the application of ink and high gloss. Calcium carbonate powders are also used in the paint, ceramic, plastics, printing inks, pigments and paper industries. It is also known that calcium carbonate is used in acid neutralization products designed for indigestion and acid reflux. The disclosed method will enhance the favorable features of these types of pharmaceutical products as well.

Superfine talc particles or powders can be used in paper manufacturing to increase opacity, improve runnability for coating, enhance gloss and quality, and reduce powdering. In polymers, strength and stiffness are increased, thermal and creep resistances are improved, nucleation/polymerization is promoted and permeability to gas and water is reduced with the use of superfine talc particles or powders. Paints and pigments also enjoy benefits such as better gloss, better cracking resistance and better water resistance. Other applications for superfine talc particles or powders include value-added functional fillers and extenders for rubber, sealants, adhesives, polishes, printing inks, pigments and textiles.

In addition to talc and calcium carbonate, kaolin, mica, zeolite, clay, aluminum hydroxide, aluminum silicate, iron oxide, magnesium oxide and silicon dioxide are also used as fillers and extenders in the manufacture of cosmetics and other applications. As observed in U.S. Pat. No. 5,755,577, however, there is still a large amount of room for improvement in the aesthetic features and performance of the resultant cosmetic products.

Other objects and advantages of the products produced by the present invention shall become apparent to those skilled in the art from the accompanying description.

2. Description of Prior Art

Historically, it is a well-known process to grind minerals in a ball mill in order to reduce the size of particles. This process, however, does not provide the ability to reduce the particle size of the majority of the particles below 2 microns equivalent spherical diameter. In order to produce particles with desirable properties, smaller particles are needed. Traditionally, chemical precipitation processes and other physical or chemical techniques have been used to provide a finer product than ball mill processes. Even as recently as 1998, improvements were being made to the precipitation process as in U.S. Pat. No. 5,741,471 to Deutsche and Wise.

In a modification to the traditional ball mill grinding method, U.S. Pat. No. 3,604,634 (“the '634 patent”) teaches a grinding method wherein an aqueous solution of at least 25 percent by weight of calcium carbonate is ground with a particulate grinding material long enough to dissipate at least 250 horsepower hours of energy per ton. According to the patent disclosure, sixteen hours of grinding using that process yielded a finished product with 97% of the particles smaller than 2 microns and 32% of the finished particles smaller than 500 nanometers.

Due to problems with spontaneous crystal dissolution-recrystallization in situations where the aqueous solution was overly saturated, U.S. Pat. No. 4,265,406 (“the '406 patent”) taught the addition of additives to the solution in order to reduce the particle size and thus increase the relative surface area of the powder.

In U.S. Pat. No. 4,325,514 (“the '514 patent”), comminution is referenced that can be performed either “wet or dry”. The method of comminution is via ball-milling. That specification, however, actually taught away from the instant invention by noting that the preferred grinding method is an aqueous slurry as opposed to a dry mixture. The '514 patent claims a method of comminuting materials involving a rotating impeller being forced through an aqueous slurry containing the subject material in solution.

Various inventive steps have subsequently made upon the basic slurry grinding model; however, the focus was on dispersing the particles for better grinding on centrifuging them in order to obtain uniformity in size. See, for example, U.S. Pat. No. 4,793,985 to Price, et. al. and U.S. Pat. No. 4,845,191 to Hautier.

Virtually all of the aforementioned slurry grinding methods have the disadvantages of a large number of steps, the addition of water to the mix during the grinding process with its attendant changes to the grinding mechanism, the addition of dispersing agents for better grinding, and purchase of a centrifuge all of which increase the cost.

The aforementioned problems and other drawbacks are solved by the present invention which provides for a new and novel method called matrix separation grinding. This new method comprises combining a subject powder such as calcium carbonate, talc or other similar mineral material with a grinding agent such as sodium chloride. The combination is then milled for a sufficient time to significantly reduce the average particle size and increase the overall surface area of the subject mineral material. After milling, the powder is washed with a solvent such as water to remove the grinding agent and isolate the ground subject powder.

It was also determined that this new grinding method, described more fully herein, is less expensive, less time consuming, and more energy efficient than currently known methods of producing superfine powders. Further, a much finer particle size is achievable because the new method does not suffer from agglomeration (cold welding) problems. The disclosed method provides a highly practical and cost effective way of manufacturing superfine mineral powders.

Further objects and advantages of my invention will become apparent from a consideration of the ensuing description by those skilled in the art.

### BRIEF DESCRIPTION OF THE DRAWINGS

FIG. 1 is a transmission electron microscope (TEM) image of calcium carbonate granules prior to undergoing matrix separation grinding (the disclosed process).

FIG. 2 is a TEM image of calcium carbonate granules after undergoing 16 hours of the matrix separation grinding process.

FIG. 3 is a graph demonstrating the increase of specific surface area as it relates to the length of time the calcium carbonate powder is ground using the disclosed method.

FIG. 4 is a TEM image of talc granules prior to undergoing matrix separation grinding.

FIG. 5 is a graph demonstrating the increase in specific surface area as it relates to the length of time the talc powder is ground using the disclosed method.

FIG. 6 is a TEM image of talc granules after undergoing 8 hours of the matrix separation grinding process.

### DESCRIPTION OF THE INVENTION-PREFERRED EMBODIMENT

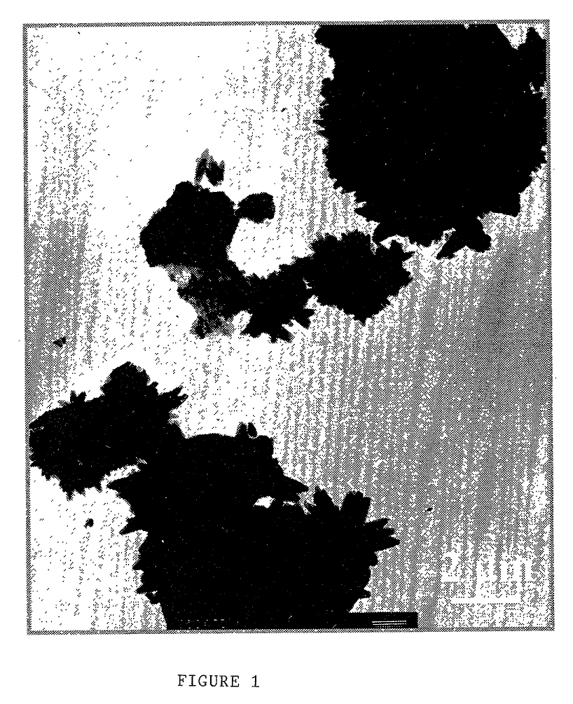

In order to practice the instant invention, any of the currently commercially available mineral materials, such as talc, calcium carbonate, zeolite, clay, aluminum hydroxide, aluminum silicate, iron oxide and magnesium oxide, should be obtained. Typically, these materials are readily available in powders with an average diameter of 2 to 5 microns. A transmission electron microscope (TEM) image of, for example, calcium carbonate, is illustrated by FIG. 1.

In one preferred embodiment, the chosen mineral material is placed in a ball milling attritor, such as the Union Process 01-HD or Union Process 1-S, along with a dry matrix separation agent, such as table salt (sodium chloride). The dry matrix separation agent can be an organic or inorganic particulate substance, but must be capable of being easily removed after grinding. Ideally, the separation agent will be harder than the target powder, readily available and cost effective. The size of the separation agent is not the ultimate determining factor; however, it must be considerably smaller than the grinding media.

As a grinding aid, the dry matrix separation agent helps to reduce the particle size of the mineral material to the desired superfine size or specific surface area. Likewise, as a separation aid, the matrix separation agent works to discourage and inhibit cold welding or agglomeration during grinding.

After the materials are combined in the attritor, the matrix separation agent and the mineral material are ground or milled in the attritor or other milling mechanism at a preferable frequency of 500 revolutions per minute, for a sufficient amount of time to produce the desired average particle size. The matrix separation agent is then removed by exposing the entire contents of the attritor after grinding to a solvent that acts to dissolve the matrix separation agent out of the mixture. In the case of our preferred embodiment, water effectively removed the table salt from the subject calcium carbonate powder.

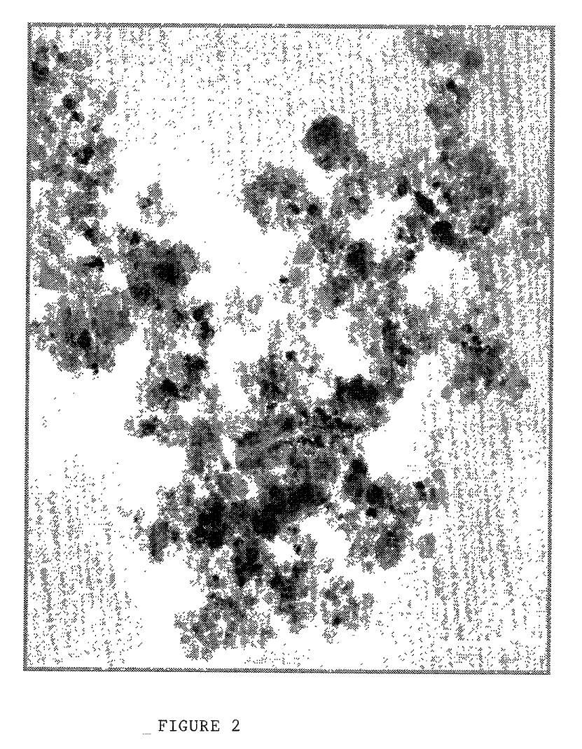

A TEM image demonstrating the mineral material shown in FIG. 1 after sixteen (16) hours of grinding using the method disclosed herein is illustrated by FIG. 2. Note that the calcium carbonate particles have average sizes in the range of twenty (20) to fifty (50) nanometers after grinding.

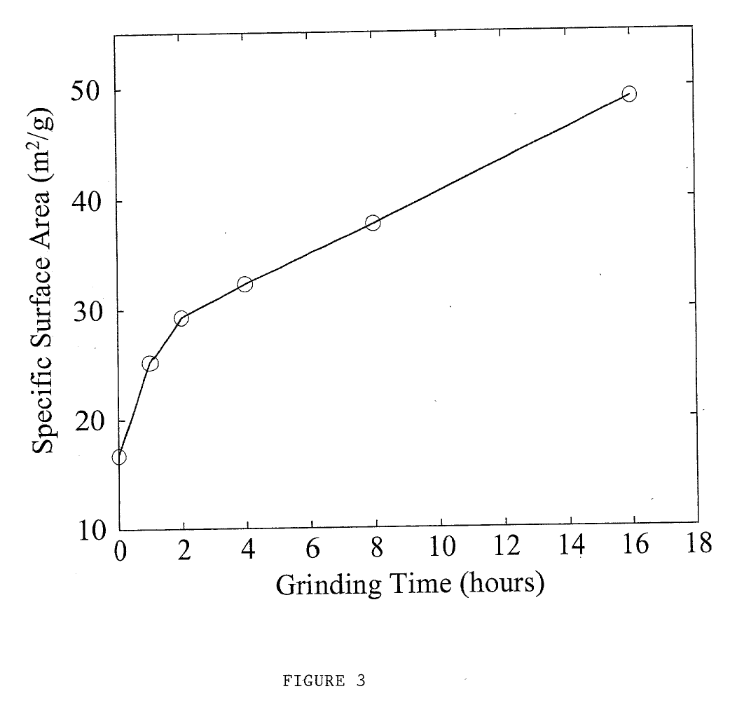

Another useful measurement of the results of the grinding using the instant process is called specific surface area. After sixteen hours of grinding the calcium carbonate granules, the specific surface area is approximately 50 meters squared per gram, calculated using the BET (Brunauer, Emmet & Teller) method. It is anticipated that the specific surface area will continue to increase even further with lengthier grinding times. This trend is depicted in FIG. 3 which shows the increase of specific surface area as it relates to the length of time the calcium carbonate powder is ground using the disclosed method.

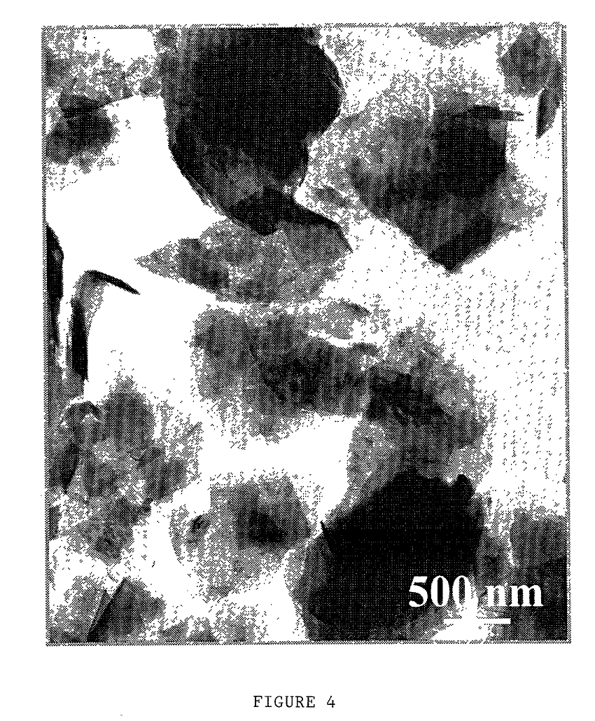

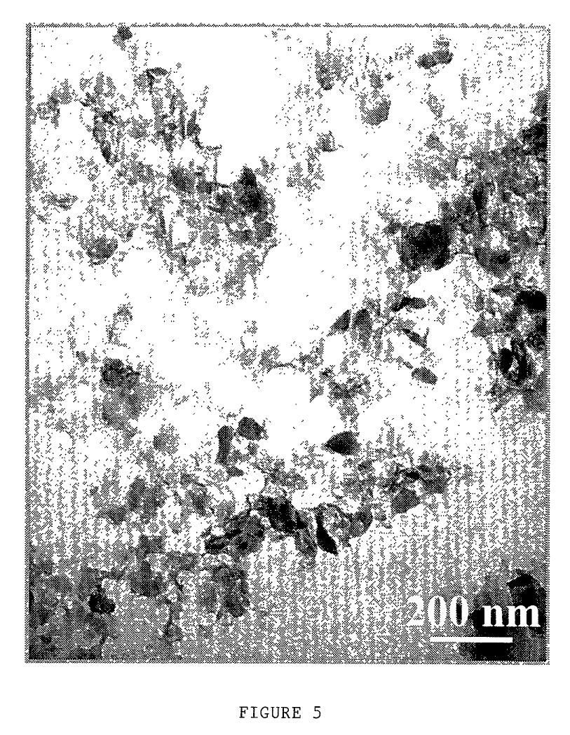

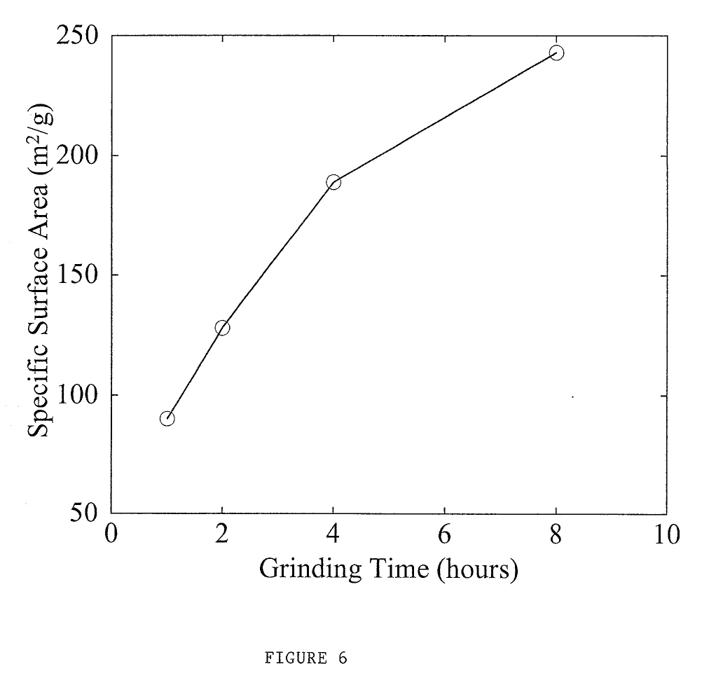

In another embodiment of the instant invention, talc was also milled using the method disclosed above. The starting talc powder was on the order of 1 micron, as with the calcium carbonate. FIG. 4 illustrates the talc powder prior to matrix separation grinding. The same procedure was used as with the calcium carbonate except that the particulate size was much smaller than with the calcium carbonate even after only eight (8) hours of grinding. As seen in FIG. 5, the specific surface area of the resultant powder approaches 250 meters squared per gram after only eight (8) hours of grinding. This corresponds to a plate-like morphology yielding an average particle size (on the longest dimension) of 100 nanometers. FIG. 6 demonstrates a TEM image taken after 8 hours of grinding and washing.

Additional trials were run using varying ratios of talc to sodium chloride. It was seen that the higher the ratio of talc to sodium chloride, the more efficient it was to produce resultant particles of a particular size. Stated another way, the mineral material was ground more efficiently when the ratio of separation agent to subject powder was increased.

It will be understood that the above description of the present invention is susceptible to various modifications, changes and adaptations, and the same are intended to be comprehended within the meaning and range of equivalents of the appended claims.

I claim:

1. A method of grinding a mineral material to obtain a superfine mineral powder comprising:
a) combining the mineral material with a dry separation agent to obtain a grinding mixture; and
b) milling said grinding mixture to obtain a superfine mineral powder.

2. A method according to claim 1, wherein the grinding mixture comprises a dry separation agent to mineral material ratio in the range between 1:1 and 16:1.

3. A method according to claim 2, wherein the mineral material is selected from the group consisting of talc, calcium carbonate, zeolite, clay, aluminum hydroxide, aluminum silicate, iron oxide and magnesium oxide.

4. A method according to claim 3, wherein the dry separation agent is selected from the group consisting of inorganic substances that can be separated from the superfine mineral powder after milling.

5. A method according to claim 3, wherein the dry separation agent is selected from the group consisting of organic substances that can be separated from the superfine mineral powder after milling.

6. A method according to claim 1, wherein the mineral material is selected from the group consisting of talc, calcium carbonate, zeolite, clay, aluminum hydroxide, aluminum silicate, iron oxide and magnesium oxide.

7. A method according to claim 6, wherein the dry separation agent is selected from the group consisting of inorganic substances that can be separated from the superfine mineral powder after milling.

8. A method according to claim 6, wherein the dry separation agent is selected from the group consisting of organic substances that can be separated from the superfine mineral powder after milling.

9. A method according to claim 1, wherein the dry separation agent is selected from the group consisting of inorganic substances that can be separated from the superfine mineral powder after milling.

10. A method according to claim 1, wherein the dry separation agent is selected from the group consisting of organic substances that can be separated from the superfine mineral powder after milling.

11. A method according to claim 1, wherein the milling occurs for a sufficient time to produce a superfine mineral powder having a predetermined surface area.

12. A method according to claim 11, wherein the pre-determined surface area is greater than 50 meters squared per gram.

13. A method according to claim 1, wherein the superfine mineral powder has a surface area greater than 50 meters squared per gram.

14. A method according to claim 1, wherein the dry separation agent is a water-soluble salt.

15. A method according to claim 1, wherein the mineral material is talc.

16. A method according to claim 15, wherein the superfine mineral powder consists of a majority of particles smaller than 500 nanometers.

17. A method according to claim 15, wherein the superfine mineral powder has a specific surface area greater than 50 meters squared per gram.

18. A method according to claim 1, wherein the mineral material is calcium carbonate.

19. A method according to claim 18, wherein the superfine mineral powder consists of a majority of particles smaller than 300 nanometers.

20. A method according to claim 18, wherein the superfine mineral powder has a specific surface area greater than 10 meters squared per gram.

21. A method according to claim 1, wherein the dry separation agent is removed from the grinding mixture after milling by washing the mixture with a solvent.

22. A method according to claim 21, wherein the dry separation agent is sodium chloride and the solvent is water.

23. A method according to claim 1, wherein the superfine mineral powder consists of a majority of particles smaller than 500 nanometers.

24. A method according to claim 1, wherein the grinding material is milled for less than 20 hours.

25. A superfine mineral powder prepared using the method of any one of the previous claims.

26. A superfine mineral powder consisting of a majority of particles smaller than 500 nanometers.

27. A superfine mineral powder as in claim 26, wherein the powder is talc.

28. A superfine mineral powder as in claim 26, wherein the powder is calcium carbonate.

29. A superfine mineral powder as in claim 26, wherein the powder is selected from the group consisting of zeolite, clay, aluminum hydroxide, aluminum silicate, iron oxide and magnesium oxide.

30. A superfine mineral powder with a specific surface area greater than 10 meters squared per gram..

31. A superfine mineral powder as in claim 30, wherein the powder is calcium carbonate.

32. A superfine mineral powder as in claim 30, wherein the powder is talc.

33. A superfine material powder as in claim 30, wherein the powder is selected from the group consisting of zeolite, clay, aluminum hydroxide, aluminum silicate, iron oxide and magnesium oxide.

34. A method of grinding a first talc powder to obtain a second talc powder with a greater specific surface area, comprising:
a) combining the first talc powder with dry sodium chloride to obtain a grinding mixture;
b) milling said grinding mixture for over two hours; and
c) immersing the grinding mixture in water to remove the sodium chloride and obtain the second talc powder.

35. A method of grinding a first calcium carbonate powder to obtain a second calcium carbonate powder with a greater specific surface area, comprising:
a) combining the first calcium carbonate powder with dry sodium chloride to obtain a grinding mixture;
b) milling said grinding mixture for over two hours; and
c) immersing the grinding mixture in water to remove the sodium chloride and obtain the second calcium carbonate powder.
